(19) United States
(12) Patent Application Publication
(10) Pub. No.: US 2008/0068515 A1
(43) Pub. Date: Mar. 20, 2008

(54) PROJECTION APPARATUS

(75) Inventors: Nan-Jiun Yin, Hsinchu (TW); Yen-Hsien Su, Hsinchu (TW); Chih-Chung Yang, Hsinchu (TW); His-Chih Sun, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/779,290

(22) Filed: Jul. 18, 2007

(30) Foreign Application Priority Data
Sep. 20, 2006 (TW) 95134753

(51) Int. Cl. H04N 5/64

(52) U.S. Cl. 348/789; 348/E05.143

(57) ABSTRACT

A projection apparatus including a projection unit, a control unit, a case, and a movable signal receiving module is provided. The projection unit is suitable to project an image beam onto a screen. The control unit is electrically connected to the projection unit, and the control unit is suitable to control the projection unit. The projection unit and the control unit are packaged by the case. In addition, the movable signal receiving module disposed outside the case includes a signal receiving unit and a signal transmission line. The signal receiving unit is suitable to receive a signal from a remote controller. One end of the signal transmission line is connected to the signal receiving unit and the other end is suitable to be electrically connected to the control unit. Moreover, the signal received by the signal receiving unit is transmitted to the control unit through the signal transmission line.

### CROSS-REFERENCE TO RELATED APPLICATION

This application claims the priority benefit of Taiwan application serial no. 95134753, filed Sep. 20, 2006. All disclosure of the Taiwan application is incorporated herein by reference.

### BACKGROUND OF THE INVENTION

1. Field of the Invention

The present invention relates to a display apparatus. More particularly, the present invention relates to a projection apparatus.

2. Description of Related Art

Referring to FIG. 1, a conventional projection apparatus 100 includes a case 110, a projection unit (not shown) disposed in the case 110, and two infrared ray (IR) receivers 130. A projection lens 120 of the projection unit is partially exposed outside the case 110. The projection unit is suitable to project an image beam onto a screen so as to form an image on the screen. Moreover, the IR receivers 130 are used to receive an IR signal from a remote controller, so as to operate the projection apparatus 100.

A front wall surface 112 of the projection apparatus 100 has an opening 140, and one IR receiver 130 is disposed at the opening 140. Furthermore, a rear wall surface 114 opposite to the front wall surface 112 has another opening (not shown), and another IR receiver 130 is disposed at the opening of the rear wall surface 114.

Since the IR receiver 130 has a small signal receiving angle, two IR receivers 130 are disposed in the projection apparatus 100 to broaden the signals receiving range. However, since the two IR receivers 130 are disposed near the front wall surface 112 and the rear wall surface 114, it is easy for the two IR receivers 130 to receive the IR signals coming from the front (i.e., in front of the front wall surface 112) or the rear (i.e., at back of the rear wall surface 114). However, it is difficult for IR receivers 130 to receive the IR signals coming from the two sides (sides of a side wall 115 and a side wall 116) of the projection apparatus 100. Therefore, IR signal receiving range of the conventional projection apparatus 100 is small.

Referring to FIGS. 2A-2C, another conventional projection apparatus 100a includes an IR receiving module 130a and a control unit (not shown). The IR receiving module 130a is disposed on a side wall 114a of the projection apparatus 100a, and the control unit is disposed inside the projection apparatus 100a and is electrically connected to the IR receiving module 130a. The IR receiving module 130a includes an upper cover 132a, a lower cover 132b, an IR receiver 134, and a plug 136. The IR receiver 134 is packaged by the upper cover 132a and the lower cover 132b. Also, the IR receiver 134 is electrically connected to the plug 136, and the plug 136 is suitable to be inserted into a jack (not shown) on the side wall 114a so as to be electrically connected to the control unit. A receiving range of the IR receiving module 130a is a sector area as shown in FIG. 2A, which has a receiving angle of 122.6°. Since the signal receiving range of the projection apparatus 100a is limited to restricted directions, the signal receiving range is small.

### SUMMARY OF THE INVENTION

Accordingly, the present invention is directed to a projection apparatus, which is capable of increasing the signal receiving range.

In order to achieve the above and other objectives, a projection apparatus which comprises a projection unit, a control unit, a case, and a movable signal receiving module is provided. The projection unit is suitable to project an image beam onto a screen. The control unit is electrically connected to the projection unit, and the control unit is suitable to control the projection unit. The projection unit and the control unit are packaged by the case. The movable signal receiving module includes a signal receiving unit and a signal transmission line. The signal receiving unit is disposed outside the case and is suitable to receive a signal from a remote controller. A free end of the signal transmission line is connected to the signal receiving unit, and a fixed end opposite to the free end is suitable to be electrically connected to the control unit. The signal received by the signal receiving unit is transmitted to the control unit through the signal transmission line.

The present invention further provides a projection apparatus, which comprises a projection unit, a control unit, a case, and a signal receiving unit. The projection unit is suitable to project an image beam onto a screen. The control unit is electrically connected to the projection unit, and the control unit is suitable to control the projection unit. The projection unit and the control unit are packaged by the case. The signal receiving unit is disposed on the case and electrically connected to the control unit. Moreover, the signal receiving unit includes a plurality of signal receivers exposed outside the case, and the signal receivers are suitable to receive a signal from a remote controller.

As the projection apparatus of the present invention includes a movable signal receiving module, the position of the movable signal receiving module can be adjusted depending on the position of a user (i.e., the position of a signal generated by the remote controller), so that the signal from the remote controller can be successfully received by the movable signal receiving module. In this manner, the problem of a small signal receiving range of the projection apparatus is alleviated.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a three dimensional view of a conventional projection apparatus.

FIG. 2A is a schematic view of a conventional projection apparatus and a signal receiving range of its IR receiving module.

FIG. 2B is a schematic view of the IR receiving module of FIG. 2A.

FIG. 2C is an exploded view of the IR receiving module of FIG. 2B.

FIG. 3A is a block diagram of a projection apparatus according to a first embodiment of the present invention.

FIG. 3B is a three dimensional view of the projection apparatus of FIG. 3A.

FIGS. 4A and 4B are three dimensional views of a projection apparatus according to a second embodiment of the present invention.

FIG. 5 is a three dimensional view of a projection apparatus according to a third embodiment of the present invention.

FIG. 6A shows a signal receiving unit with two signal receivers and a signal transmission line.

FIG. 6B shows a signal receiving unit with three signal receivers and a signal transmission line.

FIG. 7A is a schematic view of a projection apparatus according to a third embodiment of the present invention.

FIG. 7B is a schematic view of the signal receiving unit of FIG. 7A.

FIG. 7C is a schematic view of a signal receiving unit with two signal receivers.

FIG. 7D is a schematic view of an embodiment of a signal receiving unit having two signal receivers with the bottoms opposite to each other.

FIG. 7E is an exploded view of the signal receiving unit shown in FIG. 7D.

FIG. 7F is a schematic view of the projection apparatus as shown in FIG. 7A and a signal receiving range of its signal receiving unit according to an embodiment of the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

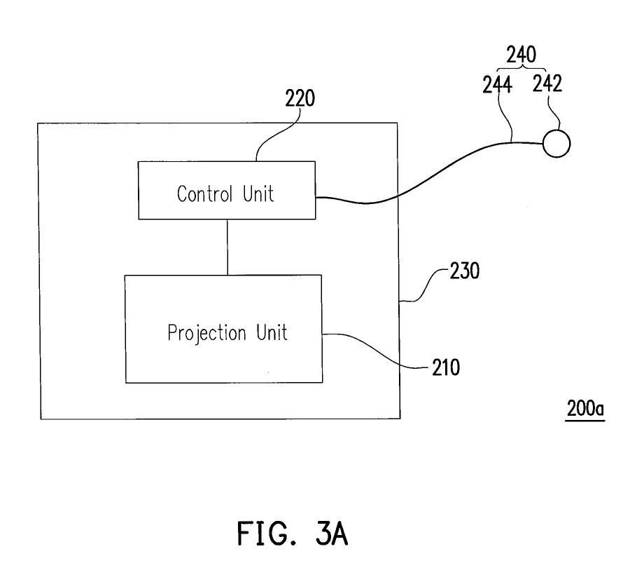

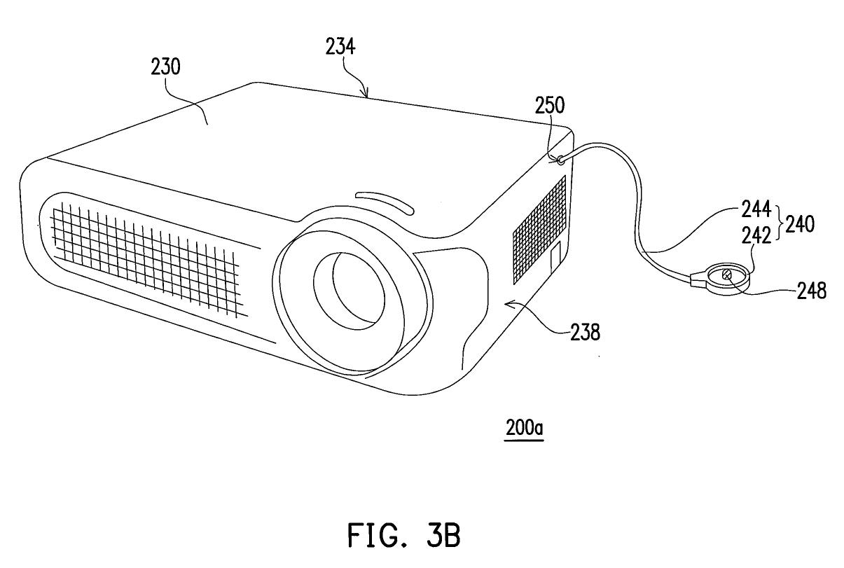

FIG. 3A is a block diagram of a projection apparatus according to a first embodiment of the present invention, and FIG. 3B is a three dimensional view of the projection apparatus of FIG. 3A. Referring to FIGS. 3A and 3B, a projection apparatus 200a in this embodiment includes a projection unit 210, a control unit 220, a case 230, and a movable signal receiving module 240. The projection unit 210 and the control unit 220 are disposed inside the case 230, and the movable signal receiving module 240 is disposed outside the case 230. The control unit 220 is electrically connected to the projection unit 210, and the movable signal receiving module 240 is suitable to be electrically connected to the control unit 220. Furthermore, the control unit 220 is suitable to control the projection unit 210 to generate an image beam and project the image beam onto a screen, so as to form an image on the screen. In addition, the movable signal receiving module 240 includes a signal receiving unit 242 and a signal transmission line 244. A free end of the signal transmission line 244 is connected to the signal receiving unit 242, and a fixed end opposite to the free end is suitable to be electrically connected to the control unit 220. The signal receiving unit 242 includes a first signal receiver 248 that is suitable to receive a signal from a remote controller. By connecting the signal transmission line 244 having one end being free to the signal receiving unit 242, the position of the receiving unit 242 can be freely adjusted based on the requirements of a user, thereby achieving a movable signal receiving module 240.

Further, the remote controller cooperates with the first signal receiver 248. For example, if the signal sent by the remote controller is an IR signal, the first signal receiver 248 is an IR receiver. Moreover, the signal received by the first signal receiver 248 is suitable to be transmitted to the control unit 220 through the signal transmission line 244, and the control unit 220 controls the projection unit 210 according to this signal.

The fixed end of the signal transmission line 244 is directly connected to the control unit 220. In particular, a through hole 250 is formed on a side wall (e.g., the side wall 238) of the case 230, such that the signal transmission line 244 passes through the through hole 250 to get into the inside of the case 230 from the outside, so as to be connected to the control unit 220.

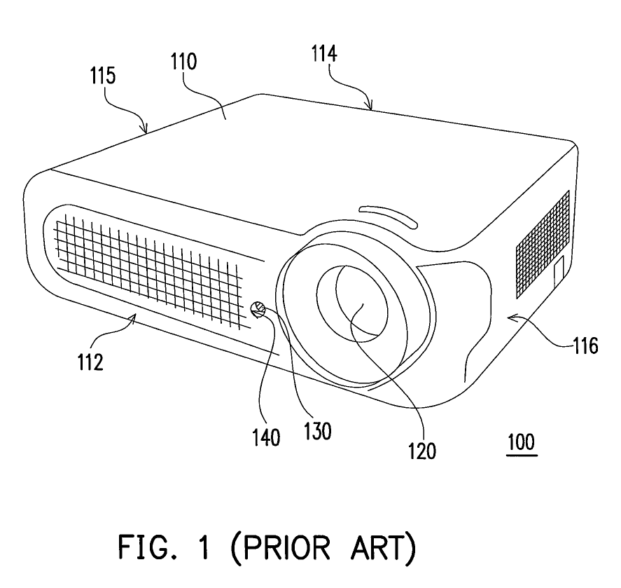

Because the signal transmission line 244 of the movable signal receiving module 240 is partially disposed outside the case 230, the position of the signal receiving unit 242 as well as a signal receiving direction can be adjusted by a user as required. For example, when the user is behind the projection apparatus 200a (i.e., at back of a rear wall surface 234 of the case 230), the signal receiving unit 242 can be moved to the backside of the projection apparatus 200a and a signal receiving direction of the first signal receiver 248 can be turned to the user. In this manner, the signal generated by the remote controller when pressed by the user is successfully received by the first signal receiver 248. Accordingly, the projection apparatus 200a in this embodiment alleviates the problem of a small signal receiving range existing in the conventional projection apparatus 100 (as shown in FIG. 1).

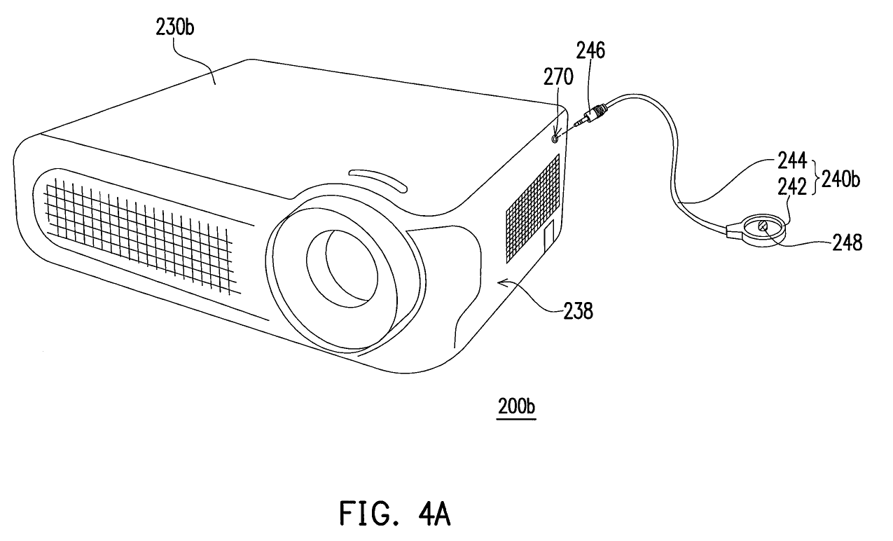

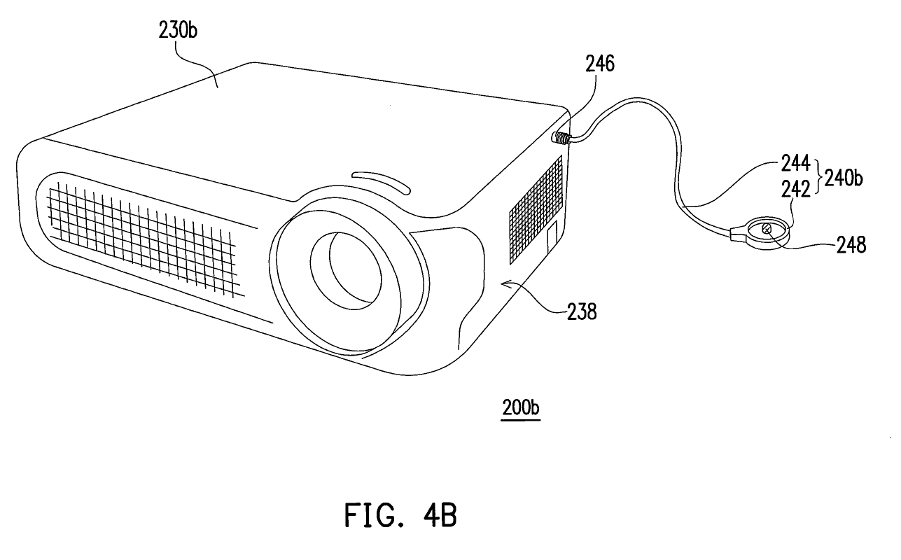

Referring to FIGS. 4A and 4B, which are three dimensional views of a projection apparatus according to a second embodiment of the present invention. FIG. 4A is a schematic view showing a movable signal receiving module 240b separated from a case 230b, and FIG. 4B is a schematic view showing the movable signal receiving module 240b electrically connecting with the control unit 220 inside the case 230b (as shown in FIG. 3A). A projection apparatus 200b in this embodiment has substantially the same structure of the projection apparatus 200a as shown in FIG. 3B, and the difference is described herein. The case 230b of the projection apparatus 200b has a jack 270 electrically connected to the control unit 220, in which the jack 270 is, for example, located in a side wall (e.g., the side wall 238) of the case 230b. Moreover, the movable signal receiving module 240b further includes a plug 246 connected to the other end of the signal transmission line 244. The plug 246 is suitable to be inserted into the jack 270 so as to be electrically connected to the jack 270. After the plug 246 is inserted into the jack 270 (as shown in FIG. 4B), the signal received by the first signal receiver 248 is transmitted to the control unit 220 via the signal transmission line 244, the plug 246, and the jack 270.

Since the movable signal receiving module 240b of the projection apparatus 200b can be separated from the case 230b, when the projection apparatus 200 is to be packed and moved, the movable signal receiving module 240b can be separated from the case 230b by the user. In this manner, the movable signal receiving module 240b exposed outside the case 230b will not bother the user when packing and moving the projection apparatus 200b.

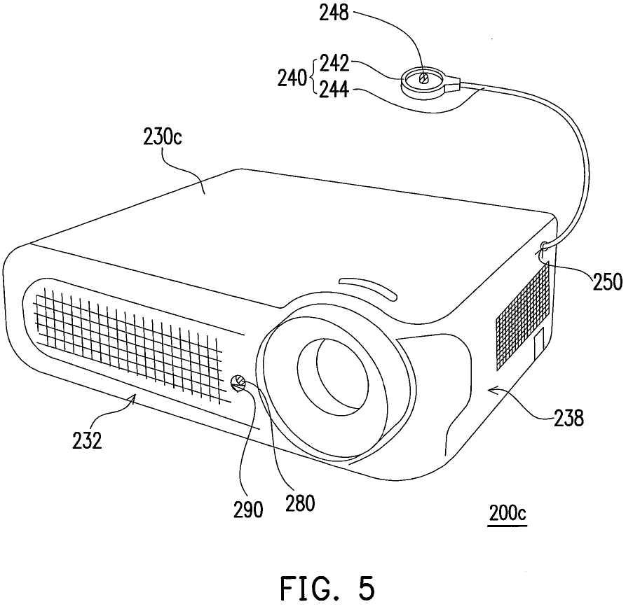

FIG. 5 is a three dimensional view of a projection apparatus according to a third embodiment of the present invention. Referring to FIG. 5, a projection apparatus 200c has substantially the same structure of the projection apparatus 200a as shown in FIG. 3, and the difference is described herein. The projection apparatus 200c further includes a second signal receiver 280 fixedly disposed inside a case 230c. The case 230c has an opening 290 which is, for example, located in a side wall (for example, the front wall 232) of the case 230c. The second signal receiver 280 is adjacent to the opening 290 and electrically connected to a control unit (not shown) inside the case 230c. Furthermore, the second signal receiver 280 is suitable to receive the signal from the remote controller, and the second signal receiver 280 coordinates with the remote controller. For example, if the signal from the remote controller is an IR signal, the second signal receiver 280 is an IR receiver.

Since the projection apparatus 200c includes the fixed second signal receiver 280 in addition to the movable signal receiving unit 242, the signal generated by the remote controller is more easily to be received by the projection apparatus 200c. Accordingly, the projection apparatus 200c in this embodiment further alleviates the problem of a small signal receiving range existing in the conventional projection apparatus 100 (as shown in FIG. 1). It should be noted that the projection apparatus 200b as shown in FIG. 4A can also include the second signal receiver 280.

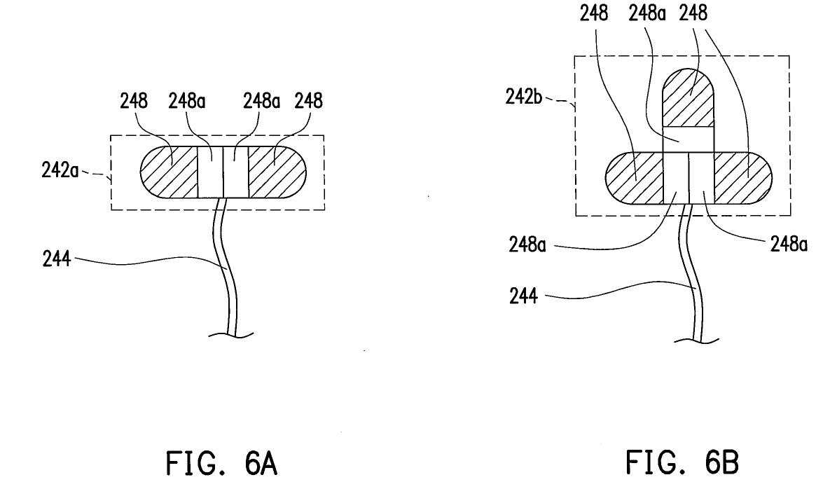

It is to be noted that the signal receiving unit 242 in the above embodiments is not limited to having only one first signal receiver 248, a signal receiving unit 242a with two first signal receivers 248 (as shown in FIG. 6A) in which the bottoms 248a of the two first signal receivers 248 are opposite to each other may also utilized. Alternatively, the signal receiving unit 242 can be replaced by a signal receiving unit 242b with three first signal receivers 248 (as shown in FIG. 6B), in which the bottoms 248a of two of the first signal receivers 248 are opposite to each other and the bottom 248a of the other first signal receiver 248 faces the area between the above two signal receivers 248 with the bottoms opposite to each other.

Since the signal receiving units 242a and 242b have a plurality of first signal receivers 248 facing different directions, the signal receiving angle is further increased.

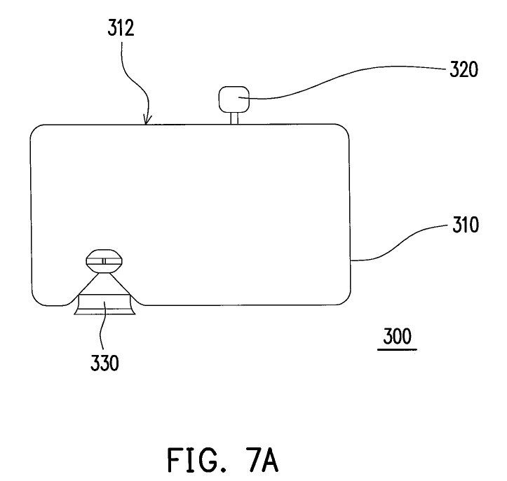

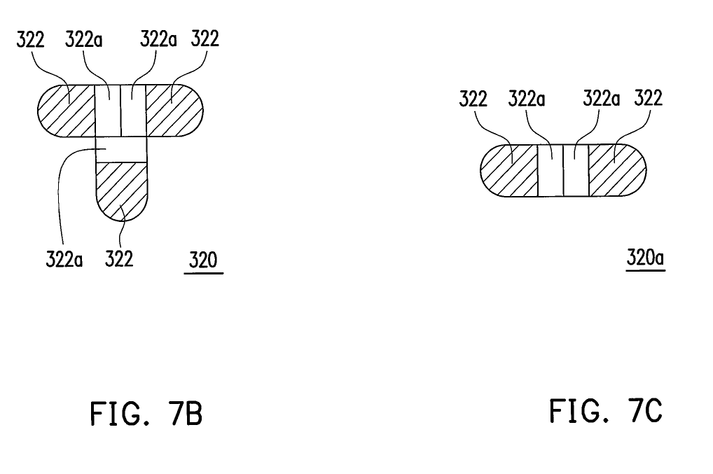

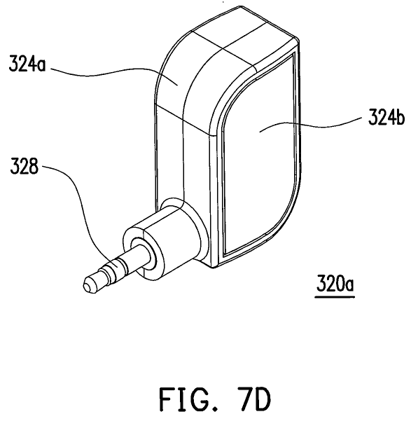

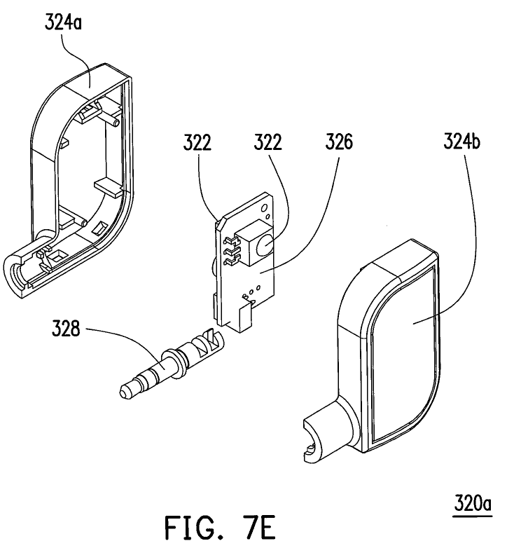

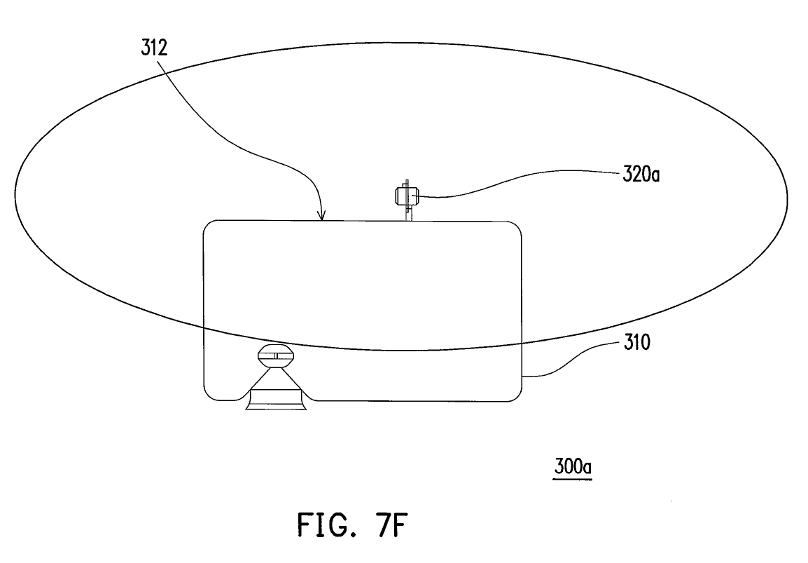

FIG. 7A is a schematic view of a projection apparatus according to a forth embodiment of the present invention. Referring to FIG. 7A, a case 310 of a projection apparatus 300 includes a top, a bottom opposite to the top, and a plurality of side walls connected between the top and the bottom. The projection apparatus 300 is substantially the same as the projection apparatus 200a, and the difference is described herein. A signal receiving unit 320 of the projection apparatus 300 is directly disposed on one of the side walls (e.g. a side wall 312) of the case 310 of the projection apparatus 300 and is electrically connected to a control unit (not shown) located inside the case 310. In other words, the projection apparatus 300 does not include the movable signal receiving module 240. Moreover, the signal receiving unit 320 is not limited to be disposed on the side wall 312 as shown in FIG. 7A in the present invention, but can be disposed on any other side wall or on the top of the projection apparatus 300.

FIG. 7B is a schematic view of the signal receiving unit of FIG. 7A. Referring to FIGS. 7A and 7B, the signal receiving unit 320 of the projection apparatus 300 has three signal receivers 322 exposed outside the case 310. These signal receivers 322 are suitable to receive a signal from a remote controller, and these signal receivers 322 are, for example, IR receivers. The bottoms 322a of two of these signal receivers 322 are opposite to each other, and the bottom 322a of the other signal receiver 322 faces the area between the above two signal receivers 322 with the bottoms 322a opposite to each other. Because the three signal receivers 322 facing respectively towards three different directions, the signal receiving angle of the signal receiving unit 320 in this embodiment is increased as compared to the conventional projection apparatus. Thus, the problem of the small signal receiving range, as in the case of the conventional projection apparatus, is alleviated.

It should be noted that the signal receiving unit 320 can be replaced by a signal receiving unit 320a with two signal receivers 322 (as shown in FIG. 7C) alternatively, in which the bottoms 322a of the two signal receivers 322 of the signal receiving unit 320a are opposite to each other.

Further, FIG. 7D shows the signal receiving unit 320a having two signal receivers with the bottoms opposite to each other, and FIG. 7E is an exploded view of the signal receiving unit as shown in FIG. 7D. Moreover, FIG. 7F is a schematic view of the projection apparatus of FIG. 7A and a signal receiving range of its signal receiving unit according to an embodiment of the present invention. Referring to FIGS. 7D-7F, the signal receiving unit 320a includes two signal receivers 322 with their bottoms opposite to each other, two side covers 324a, 324b, a carrier 326, and a plug 328. The two signal receivers 322 are carried by the carrier 326 and electrically connected to the plug 328 via the carrier 326. The plug 328 is suitable to be inserted into a jack (not shown) located on the side wall 312 of the case 310 of the projection apparatus 300a, so as to be electrically connected to the control unit.

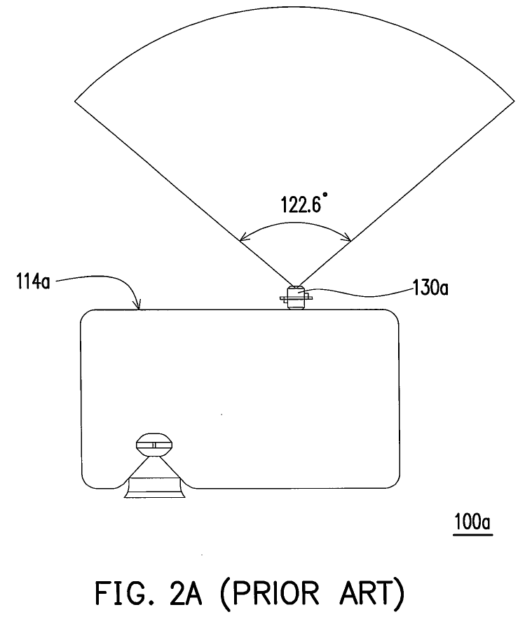

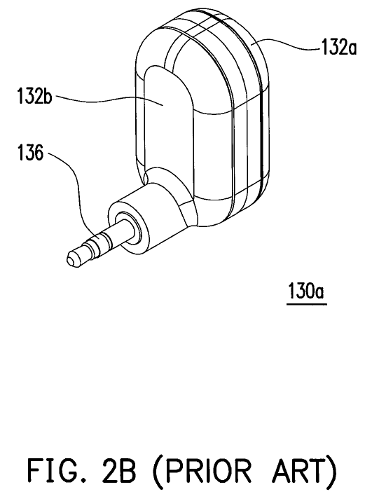

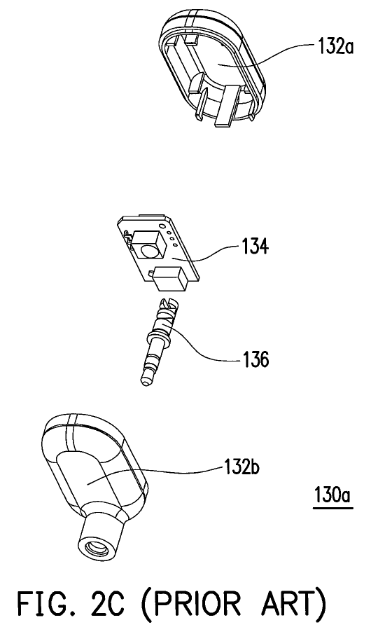

The receiving range of the signal receiving unit 320a is an oval area as shown in FIG. 7F. Comparing FIG. 7F with FIG. 2A, the oval area of FIG. 7F covers the signal receiving range that cannot be covered by the sector area of FIG. 2A. Thus, this embodiment alleviates the problem of the small signal receiving range existing in the conventional projection apparatus.

In view of the above, the projection apparatus of the present invention has at least the following advantages:

1. The movable signal receiving module is used in the projection apparatus according to an embodiment of the present invention, the position of the signal receiving unit and the signal receiving direction can be adjusted by the user as required, so that the problem of the small signal receiving range existing in the conventional projection apparatus is alleviated.

2. In an embodiment of the present invention, the movable signal receiving module is removable from the case, so it is convenient for the user to pack and move the projection apparatus.

3. In an embodiment of the present invention, the projection apparatus further includes a second signal receiver, so the problem of the small signal receiving range existing in the conventional projection apparatus is further alleviated.

4. In an embodiment of the present invention, the signal receiving unit has a plurality of signal receivers facing towards different directions, so the problem of the small signal receiving range existing in the conventional projection apparatus is further alleviated.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a projection unit, for projecting an image beam onto a screen;
a control unit, electrically connected to the projection unit, for controlling the projection unit;
a case, for packaging the projection unit and the control unit; and
a movable signal receiving module, comprising:
a signal receiving unit, disposed outside the case, for receiving a signal from a remote controller; and
a signal transmission line, having a free end connected to the signal receiving unit and a fixed end opposite to the free end and electrically connected to the control unit, and a signal received by the signal receiving unit being transmitted to the control unit through the signal transmission line.

2. The projection apparatus as claimed in claim 1, wherein the case has a jack electrically connected to the control unit, and the movable signal receiving module further comprises a plug connected to the fixed end of the signal transmission line, and the plug is suitable to be inserted into the jack so as to be electrically connected to the jack.

3. The projection apparatus as claimed in claim 1, wherein the signal receiving unit comprises a first signal receiver.

4. The projection apparatus as claimed in claim 3, wherein the first signal receiver comprises an infrared ray (IR) receiver.

5. The projection apparatus as claimed in claim 1, wherein the signal receiving unit comprises two first signal receivers, and bottoms of the first signal receivers are disposed opposite to each other.

6. The projection apparatus as claimed in claim 5, wherein the first signal receivers comprise IR receivers.

7. The projection apparatus as claimed in claim 1, wherein the signal receiving unit comprises three first signal receivers, bottoms of two of the first signal receivers are disposed opposite to each other, and a bottom of the remaining first signal receiver faces an area between the two first signal receivers.

8. The projection apparatus as claimed in claim 7, wherein the first signal receivers comprise IR receivers.

9. The projection apparatus as claimed in claim 1, further comprising a second signal receiver fixedly disposed inside the case and is electrically connected to the control unit, and the second signal receiver is suitable to receive a signal from the remote controller.

10. The projection apparatus as claimed in claim 9, wherein the second signal receiver comprises an IR receiver.

11. A projection apparatus, comprising:
a projection unit, for projecting an image beam onto a screen;
a control unit, electrically connected to the projection unit, for controlling the projection unit;
a case, for packaging the projection unit and the control unit; and
a signal receiving unit, disposed on the case and electrically connected to the control unit, the signal receiving unit comprising a plurality of signal receivers exposed outside the case, and the signal receivers being capable of receiving a signal from a remote controller.

12. The projection apparatus as claimed in claim 11, wherein the signal receiving unit comprises two signal receivers, and bottoms of the signal receivers are disposed opposite to each other.

13. The projection apparatus as claimed in claim 11, wherein the signal receiving unit comprises three signal receivers, and bottoms of two of the signal receivers are disposed opposite to each other and a bottom of the remaining signal receiver faces an area between the two signal receivers.

14. The projection apparatus as claimed in claim 11, wherein the signal receivers comprise IR receivers.

15. The projection apparatus as claimed in claim 11, wherein the case is formed with a jack electrically connected to the control unit, and the signal receiving unit further comprises a plug electrically connected to the signal receivers, and the plug is suitable to be inserted into the jack so as to be electrically connected to the jack.

16. The projection apparatus as claimed in claim 11, wherein the case comprises a top, a bottom opposite to the top, and a plurality of side walls connected between the bottom and the top, and the signal receiving unit is disposed on one of the side walls, the top, and the bottom.
